(19) United States
(12) Patent Application Publication
(10) Pub. No.: US 2023/0408037 A1
(43) Pub. Date: Dec. 21, 2023

(54) COUPLING DEVICE AND CRYOGENIC REFUELLING ARRANGEMENT

(71) Applicants: Linde GmbH, Pullach (DE); Butting CryoTech GmbH, Burgkirchen (DE)

(72) Inventors: Florian EHEGARTNER, Pullach (DE); Bernhard REITER, Grabenstätt (DE)

(21) Appl. No.: 18/247,698

(22) PCT Filed: Oct. 1, 2021
(86) PCT No.: PCT/EP2021/025376

§ 371 Date: Apr. 3, 2023

(30) Foreign Application Priority Data
Oct. 2, 2020 (EP) 20020449.3

(51) Int. Cl. F17C 13/04

(52) U.S. Cl. CPC F17C 13/04; F17C 2223/0161; F17C 2205/0326; F17C 2205/037; F17C 2265/065; F17C 2221/012; F17C 2270/0168

(57) ABSTRACT

A coupling device (1) for a cryogenic refueling arrangement (3), having a valve (9), which is arranged between an inlet (5) and an outlet (7) of the coupling device (1), a primary drive mechanism (11) for opening and closing the valve (9), and a secondary drive mechanism (13) separate from the primary drive mechanism (11), wherein the primary drive mechanism (11) has a switch (10) which is connected upstream of the valve (9), and wherein the secondary drive mechanism (13) opens the switch (10) in order to close the valve (9) as soon as a pulling force (F) acting on the coupling device (1) exceeds a predetermined value.

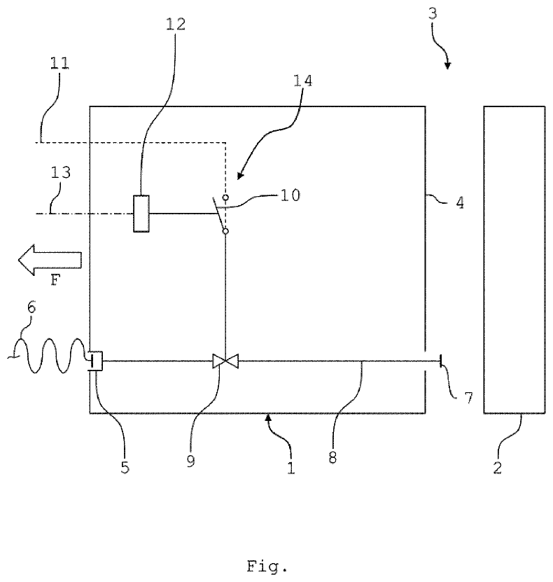

The invention relates to a coupling device for a cryogenic refueling arrangement and to a cryogenic refueling arrangement with such a coupling device.

A cryogenic refueling system comprises a storage container which can be coupled to a storage container of the vehicle with the aid of a refueling hose or pipe, a coupling device provided on the refueling hose or pipe, and a receiving nozzle provided on a vehicle, so that the vehicle can be refueled with cryogenic media, such as hydrogen. Here, to prevent damage to the coupling device, the receiver nozzle, or further components of the cryogenic refueling system, it is desirable for only the lowest possible pulling force to be applied to the coupling device in the refueling operation.

Against this background, it is an object of the present invention to provide an improved coupling device.

Accordingly, a coupling device for a cryogenic refueling arrangement is proposed. The coupling device comprises a valve which is arranged between an inlet and an outlet of the coupling device, a primary drive mechanism for opening and closing the valve, and a secondary drive mechanism separate from the primary drive mechanism, wherein the primary drive mechanism has a switch upstream of the valve, and wherein the secondary drive mechanism opens the switch in order to close the valve as soon as a pulling force acting on the coupling device exceeds a predetermined value.

In a further development, a coupling device for a cryogenic refueling arrangement is proposed. The coupling device comprises a valve which is arranged between an inlet and an outlet of the coupling device, a primary drive mechanism for opening and closing the valve, and a secondary drive mechanism separate from the primary drive mechanism, which secondary drive mechanism is configured to close the valve as soon as a pulling force acting on the coupling device exceeds a predetermined value.

Due to the fact that the valve closes as soon as the pulling force exceeds the predetermined value, it is possible on the one hand to stop the supply of a cryogen independently of the primary drive mechanism and, on the other hand, the coupling device can automatically separate from a receiver nozzle of the cryogenic refueling arrangement when the predetermined value of the pulling force is exceeded. For this purpose, a locking mechanism is released, for example. Damage to the coupling device, the receiver nozzle, and/or the locking mechanism is reliably prevented.

The coupling device can also be referred to as a coupling, a hydrogen coupling device, or a hydrogen coupling. The coupling device is suitable for being accommodated in the receiver nozzle of a vehicle in order to refuel the vehicle. A tank hose is assigned to the coupling device. The tank hose can be part of the coupling device. The valve is preferably an open-close valve. This means that the valve is in particular either completely opened or completely closed. The inlet and the outlet are in particular also part of the coupling device.

The secondary drive mechanism can be electrical, pneumatic, or mechanical. With the aid of the primary drive mechanism, the valve is closed and opened in normal operation. The secondary drive mechanism is suitable for bypassing or overriding the primary drive mechanism and thus closing the valve independently of the primary drive mechanism. The fact that the first drive mechanism is “separate” from the second drive mechanism means in the present case means that the first drive mechanism and the second drive mechanism are not identical. The first drive mechanism and the second drive mechanism are thus different from one another. The secondary drive mechanism is used in particular only in an emergency, in particular when the pulling force reaches the predetermined value. The secondary drive mechanism can be realized, for example, with the aid of a wire or a cable pull, which device is placed under tension before the tank hose is under tension and brings an excessively high pulling force into the coupling device.

The coupling device can comprise a signal transmitter. However, the signal transmitter can also be assigned to the aforementioned receiver nozzle. The signal transmitter, the switch, the primary drive mechanism and/or the secondary drive mechanism can together form an emergency separation mechanism of the coupling device. This emergency separation mechanism can also comprise the valve. The signal transmitter is suitable for opening or closing the switch as a function of the secondary drive mechanism. In particular, the switch is coupled or operatively connected to the secondary drive mechanism with the aid of the signal transmitter. This means in particular that the secondary drive mechanism opens the switch with the aid of the signal transmitter in order to close the valve as soon as the pulling force acting on the coupling device exceeds the predetermined value. The predetermined value of the pulling force can be adjustable or variable.

According to one embodiment, the valve is closed in an initial state, wherein the valve opens with the aid of the primary drive mechanism.

The valve is in particular closed in an initial state or normal state. This means, for example, in the case that the valve is pneumatically controlled, that the valve only opens as soon as pneumatic pressure is applied to the valve. As soon as this pneumatic pressure no longer acts, the valve closes again automatically.

According to a further embodiment, the valve automatically moves into the initial state as soon as the secondary drive mechanism opens the switch.

In the present case, “automatically” means, in particular, that no external power supply or external drive is required in order to bring the valve into the initial state. This can be achieved, for example, with the aid of a spring element, which closes the valve and thus brings it into the initial state. By way of example, a compressed air supply to the valve is interrupted by the opening of the switch. As soon as the valve is no longer acted upon with compressed air, it closes automatically.

According to a further embodiment, the valve is pneumatically controlled.

However, the valve can also be hydraulically or even electrically controlled.

According to a further embodiment, a switch is connected upstream of the valve, which switch can be controlled with the aid of a signal transmitter.

Depending on the secondary drive mechanism, the signal transmitter is suitable for opening and closing the valve. As soon as the switch is opened, the valve closes.

According to a further embodiment, the secondary drive mechanism opens the switch in order to close the valve.

The secondary drive mechanism can, for example, be a cable pull, with the aid of which the signal transmitter opens the switch. The secondary drive mechanism can also be a Bowden cable.

According to a further embodiment, the switch is a pneumatic switch.

However, the switch can also be an electromagnetic, a mechanical, an optical, a hydraulic switch or an electrical switch.

According to a further embodiment, the signal transmitter converts the secondary drive mechanism into a signal for opening the switch.

The signal can be a pneumatic signal.

According to a further embodiment, the secondary drive takes place electrically, pneumatically, hydraulically, or with the aid of a cable pull or Bowden cable.

The secondary drive can be selected as desired. The secondary drive can be a movement of the cable pull or Bowden cable. For example, the cable or Bowden cable is placed under tension before the tank hose itself comes under tension. This can be achieved in that the cable pull has a shorter length than the tank hose.

According to a further embodiment, the primary drive mechanism is pneumatic or hydraulic.

The primary drive mechanism can also be selected as desired.

Furthermore, a cryogenic refueling arrangement with such a coupling device and a receiver nozzle for receiving the coupling device is proposed.

The coupling device can be inserted into the receiver nozzle. A refueling process can then be carried out in an automated manner. With the aid of the secondary drive mechanism, the refueling process can be interrupted at any time and the coupling device can be ejected from the receiver nozzle. The receiver nozzle is preferably provided on a vehicle. The coupling device, on the other hand, is preferably provided on a fuel dispenser. The receiver nozzle is thus preferably arranged on the vehicle side, whereas the coupling device is preferably provided on the fuel dispenser side.

According to one embodiment, the cryogenic refueling arrangement further comprises a signal transmitter which converts the secondary drive into a signal for opening the switch.

The signal transmitter is in particular placed between the secondary drive mechanism and the switch. The secondary drive mechanism is thus operatively connected or coupled to the switch in particular with the aid of the signal transmitter.

According to a further embodiment, the signal transmitter is provided on the coupling side or on the receiver side.

This means, in particular, that the signal transmitter can be part of the coupling device or part of the receiver nozzle. However, the signal transmitter is particularly preferably part of the coupling device.

According to a further embodiment, the signal transmitter acts as a force buffer.

This is to be understood in particular as meaning that the signal transmitter opens the switch and thus closes the valve only when the predetermined value of the pulling force is reached. If pulling forces are applied that are below the predetermined value, the signal transmitter does not control the switch and the valve thus remains open.

According to a further embodiment, the predetermined value of the pulling force can be adjusted with the aid of an exchange of components of the signal transmitter.

The components can be, for example, spring elements or the like. It is thus possible, for example, to adapt the signal transmitter and thus the coupling device to any predetermined values of the pulling force. This enables, for example, a simple adaptation of the cryo-fueling arrangement or the coupling device to different vehicle types. The predetermined value of the pulling force is thus easily adaptable depending on the vehicle type. This can be realized by an easily replaceable spring element or a spring carriage provided directly on the coupling device.

According to a further embodiment, the signal transmitter has a spring element and/or sensors in order to actuate the switch as soon as the pulling force acting on the coupling device exceeds the predetermined value.

The sensors can be, for example, optical sensors, magnetic sensors, or the like. A light curtain, an optical signaling, and/or a coupling of sensors in or on a support arm or in or on the tank hose can be provided.

According to another embodiment, the coupling device and the receiver nozzle are movable from a locked state to an unlocked state and vice versa, wherein the secondary drive mechanism opens the switch before a moving of the coupling device and the receiver nozzle from the locked state to the unlocked state in order to close the valve.

In the locked state, the coupling device and the receiver nozzle are locked, in particular, with a positive fit. A positive-fit connection is produced by the two connection partners engaging with each other or behind each other. As a result, it can advantageously be achieved that first the valve is closed and only then does an unlocking and a separation of the coupling device and the receiver nozzle take place. In particular, simultaneously with the opening of the switch, or with a short time delay, a locking mechanism between the coupling device and the receiver nozzle can be released so that the coupling device slips out of the receiver nozzle or is ejected therefrom before excessive pulling forces can be transmitted to said nozzle.

According to a further embodiment, the coupling device and the receiver nozzle are moved from the locked state into the unlocked state with the aid of the secondary drive mechanism.

The secondary drive mechanism can be used for further processes independently of the primary drive mechanism. For example, a triggering of a pressure relief or an inerting can be realized. Furthermore, the secondary drive mechanism can also be used for safe unlocking and ejection of the coupling device from the receiver nozzle.

The embodiments and features described for the proposed coupling device apply accordingly to the proposed cryogenic refueling arrangement and vice versa.

Further possible implementations of the coupling device and/or of the cryogenic refueling arrangement also comprise not explicitly mentioned combinations of features or embodiments described above or below with respect to the exemplary embodiments. A person skilled in the art will also add individual aspects as improvements or additions to the respective basic form of the coupling device and/or of the cryogenic refueling arrangement.

Further advantageous embodiments and aspects of the coupling device and/or of the cryogenic refueling arrangement are the subject matter of the subclaims and of the exemplary embodiments of the coupling device and/or of the cryogenic refueling arrangement described below. The coupling device and/or the cryogenic refueling arrangement are explained below in more detail with reference to the accompanying FIGURE, based on preferred embodiments.

The FIGURE shows a schematic view of an embodiment of a cryogenic refueling arrangement.

In the FIGURE, identical or functionally equivalent elements have been provided with the same reference signs unless otherwise indicated.

The FIGURE shows a schematic sectional view of an embodiment of a coupling device 1. The coupling device 1 can engage in a corresponding receiver nozzle 2. The receiver nozzle 2 can be provided on a vehicle. For example, the receiver nozzle 2 can be a tank nozzle. The coupling device 1 and the receiver nozzle 2 together form a cryogenic refueling arrangement 3.

The cryogenic refueling arrangement 3 can also be referred to as a cryogenic refueling arrangement. The cryogenic refueling arrangement 3 is suitable for refilling a storage container with a cryogen or a cryogenic medium, for example. The cryogen can be, for example, liquid hydrogen, monosilane, ethylene, or the like.

The coupling device 1 comprises a housing 4. For example, a user can grip the housing 4 in order to insert it into the receiver nozzle 2. The coupling device 1 comprises an inlet 5 to which a tank hose 6 can be coupled. Furthermore, the coupling device 1 has an outlet 7. The inlet 5 is coupled to the outlet 7 via a line 8. A controllable valve 9 is arranged in the line 8. The valve 9 can be an on-off valve. This means that the valve 9 is either completely opened or completely closed. The valve 9 can be a pneumatic valve. In particular, the valve 9 is closed in an initial state thereof (normally closed). For example, the valve 9 is opened by applying compressed air. As soon as the supply of compressed air is interrupted, the valve 9 closes automatically. The valve 9 can be spring-reset or spring-preloaded in the direction of the initial state.

A switch 10 is assigned to the valve 9. Via a primary drive mechanism 11, the valve 9 can be controlled when the switch 10 is closed in order to open and close the valve 9. The primary drive mechanism 11 can be a pneumatic line. However, the primary drive mechanism 11 can also be an electrically conductive cable or a fiber optic line. It is assumed below that the primary drive mechanism 11 is a pneumatic line. The switch 10 is part of the primary drive mechanism 11. The switch 10 can be moved from a closed state (shown by dashed lines) into an open state (shown by solid lines) and vice versa.

A signal transmitter 12 is also assigned to the valve 9. The signal transmitter 12 can also be provided on the receiver nozzle 2. A secondary drive mechanism 13 is coupled to the signal transmitter 12, which in turn is operatively connected to the switch 10. The switch 10, the primary drive mechanism 11, the signal transmitter 12 and the secondary drive mechanism 13 together form an emergency separation mechanism 14 of the coupling device 1. The switch 10 can also be part of the secondary drive mechanism 13. This means in particular that the switch 10 can be part of both drive mechanisms 11, 13. The emergency separation mechanism 14 can also comprise the valve 9. The signal transmitter 12 is suitable for opening or closing the switch 10 as a function of the secondary drive mechanism 13.

In the simplest case, the signal transmitter 12 can be a spring element. However, the signal transmitter 12 can also comprise a sensor, for example an optical sensor, or can be a sensor. The signal transmitter 12 can operate optically, for example in the form of a light curtain. The signal transmitter 12 can comprise sensors which are provided in or on a support arm and/or in or on the tank hose 6.

In the closed state of the switch 10, the primary drive mechanism 11 applies pressure to the valve 9 so that the valve 9 is opened. As soon as the signal transmitter 12 opens the switch 10 with the aid of the secondary drive mechanism 13, the pneumatic pressure is no longer applied to the valve 9 and the valve closes automatically. In normal operation, the valve 9 integrated in the coupling device 1 is controlled via the primary drive mechanism 11. In normal operation, the coupling device 1 is in engagement with the receiver nozzle 2 and the valve 9 is open so that the cryogen flows into the storage container. The coupling device 1 is fixedly connected to the receiver nozzle 2 by means of a locking mechanism (not shown).

When a pulling force F is applied to the coupling device 1, for example when the tank hose 6 is fully deployed and is under tension, it is desirable to prevent an excessive loading of the locking mechanism, the coupling device 1, and/or the receiver nozzle 2. In this way, damage to the locking mechanism, the coupling device 1, the receiver nozzle 2, the storage container, and/or a receiver pipeline system can be prevented.

The secondary drive mechanism 13, the signal transmitter 12, and the switch 10 are provided in order to achieve this goal. Independently of the primary drive mechanism 11, the secondary drive mechanism 13 can open the switch 10 in order to close the valve 9. The secondary drive 13 can take place for example electrically, pneumatically or with the aid of a cable pull. In the case in which the secondary drive mechanism 13 is a cable pull, it can be dimensioned by its length such that it is tensioned and activates the signal transmitter 12 and thus opens the switch 10 before the tank hose 6 is fully deployed, and in this way the pulling force F acts on the coupling device 1 or on the tank hose 6. The secondary drive mechanism 13 can also be used with the aid of an infrared light barrier, microwaves or with RFID (Radio Frequency Identification).

The signal transmitter 12 thus acts as a force buffer. That is, as long as the acting pulling force F does not increase beyond a predetermined value, the signal transmitter 12 does not open the switch 10. The switch 10 is only opened and the valve 9 closed when the predetermined value of the pulling force F is reached or exceeded.

With the aid of the secondary drive mechanism 13, it is thus possible to control the valve 9 independently of the primary drive mechanism 11. Opening the switch 10 results in the valve 9 being brought into a safe state, namely into the closed state. With the opening of the switch 10, the locking mechanism can be released at the same time or with a short time delay so that the coupling device 1 slips out of the receiver nozzle 2 or is ejected therefrom before excessive forces can be transmitted to said nozzle.

The secondary drive mechanism 13 with the signal transmitter 12 and the switch 10 can be used for further processes independently of the primary drive mechanism 11 of the coupling device 1. For example, a triggering of a pressure relief or an inerting can be realized. Furthermore, the secondary drive mechanism 13 can also be used for safe unlocking and ejection of the coupling device 1.

The pulling force F is not introduced into the receiver nozzle 2. Rather, the coupling device 1 can comprise a damping system, the compensation forces of which are adjustable. The pulling force F acting on the tank hose 6 is compensated in a guided spring which is integrated directly in the coupling device 1. A spring travel that results depending on the pulling force F is transmitted mechanically to the secondary drive mechanism 13, which interrupts the pneumatic supply of the valve 9 with the aid of the switch 10 at a maximum permissible stroke. As a result, the valve 9 can be closed and the fluid flow of the cryogen can thereby be stopped.

An unintentionally occurring pulling force F, which could cause damage to the coupling device 1 and/or the receiver nozzle 2, is thus converted purely mechanically into a pneumatic signal. This in turn can be further processed with actions for bringing about a safe system state. In addition, starting from a force latency to be set the pulling force F is transmitted to the locking mechanism in such a way that the fixed locking is released and the coupling device 1 falls away from the receiver nozzle 2. It is advantageously possible to close the valve 9 before a separation process of the coupling device 1 and the receiver nozzle 2 is initiated.

Although the present invention has been described with reference to exemplary embodiments, it can be modified in many ways within the scope of the claims.

### REFERENCE SIGNS USED

1 Coupling device
2 Receiver nozzle
3 Cryogenic refueling arrangement
4 Housing
5 Inlet
6 Tank hose
7 Outlet
8 Line
9 Valve
10 Switch
11 Primary drive mechanism
12 Signal transmitter
13 Secondary drive mechanism
14 Emergency separation mechanism
F Pulling force

1. A coupling device for a cryogenic refueling arrangement, having a valve which is arranged between an inlet and an outlet of the coupling device, a primary drive mechanism for opening and closing the valve, and a secondary drive mechanism separate from the primary drive mechanism, wherein the primary drive mechanism has a switch upstream of the valve, and wherein the secondary drive mechanism opens the switch in order to close the valve as soon as a pulling force acting on the coupling device exceeds a predetermined value.

2. The coupling device according to claim 1, wherein the valve is closed in an initial state, and wherein the valve opens with the aid of the primary drive mechanism.

3. The coupling device according to claim 2, wherein the valve automatically moves into the initial state as soon as the secondary drive mechanism opens the switch.

4. The coupling device according to claim 1, wherein the valve is pneumatically controlled.

5. The coupling device according to claim 1, wherein the switch is a pneumatic switch.

6. The coupling device according to claim 1, wherein the secondary drive is implemented electrically, pneumatically, hydraulically, or with the aid of a cable pull.

7. The coupling device according to claim 1, wherein the primary drive mechanism is pneumatic or hydraulic.

8. A cryogenic refueling arrangement having a coupling device according to claim 1 and a receiver nozzle for receiving the coupling device.

9. The cryogenic refueling arrangement according to claim 8, further comprising a signal transmitter that converts the secondary drive mechanism into a signal for opening the switch.

10. The cryogenic refueling arrangement according to claim 9, wherein the signal transmitter is provided on the coupling side or on the receiver side.

11. The cryogenic refueling arrangement according to claim 9, wherein the signal transmitter acts as a force buffer.

12. The cryogenic refueling arrangement according to claim 9, wherein the predetermined value of the pulling force is adjustable with the aid of an exchanging of components of the signal transmitter.

13. The cryogenic refueling arrangement according to claim 9, wherein the signal transmitter has a spring element and/or sensors to control the switch as soon as the pulling force acting on the coupling device exceeds the predetermined value.

14. The cryogenic refueling arrangement according to claim 8, wherein the coupling device and the receiver nozzle can be moved from a locked state to an unlocked state and vice versa, and wherein the secondary drive mechanism opens the switch before a moving of the coupling device and the receiver nozzle from the locked state to the unlocked state in order to close the valve.

15. The cryogenic refueling arrangement according to claim 14, wherein the moving of the coupling device and the receiver nozzle from the locked state to the unlocked state takes place with the aid of the secondary drive mechanism.
